(19) United States
(12) Patent Application Publication
(10) Pub. No.: US 2018/0161937 A1
(43) Pub. Date: Jun. 14, 2018

(54) METHOD FOR REMOVING TRANSPARENT MATERIAL USING LASER WAVELENGTH WITH LOW ABSORPTION CHARACTERISTIC

(71) Applicant: Applied Materials, Inc., Santa Clara, CA (US)

(72) Inventor: Jeffrey L. FRANKLIN, Albuquerque, NM (US)

(21) Appl. No.: 15/573,084

(22) PCT Filed: May 16, 2016
(86) PCT No.: PCT/US2016/032792

§ 371 Date: Nov. 9, 2017

Related U.S. Application Data
(60) Provisional application No. 62/161,449, filed on May 14, 2015.

(51) Int. Cl. B23K 26/361; B23K 26/352; B26F 3/06

(52) U.S. Cl. CPC B23K 26/361; B23K 2203/42; B26F 3/06; B23K 26/352

(57) ABSTRACT

According to embodiments, a method of selectively ablating an optically transparent material covering a metal layer of a device may comprise: providing a layer of optically transparent material on a metal layer; and irradiating a portion of the layer of optically transparent material with a defocused or shaped laser beam and ablating the portion of the layer of optically transparent material; wherein the ablating leaves the metal layer completely intact and wherein the laser light has a wavelength within a range of 355 nm to 1070 nm and wherein the layer of optically transparent material absorbs less than or equal to 50% of the laser light from the laser beam on a single pass of the laser light through the layer of optically transparent material. Apparatus for laser ablation of a layer of transparent material on a metal layer, while leaving the metal layer completely intact are described.

### CROSS-REFERENCE TO RELATED APPLICATIONS

This application claims the benefit of U.S. Provisional Application No. 62/161,449 filed May 14, 2015, incorporated in its entirety herein.

### FIELD

Embodiments of the present disclosure relate generally to methods for manufacturing microelectronic and electrochemical devices, and more specifically, although not exclusively, to methods and apparatuses for improved laser ablation of transparent materials without damaging underlying metal layers in the manufacturing of thin film batteries.

### BACKGROUND

Lasers can be used to remove thin and thick film materials from substrates or other films Typically the type of laser to be used is dependent on the absorption characteristic of the film or material to be removed. High absorption with minimal reflectance or transmission is generally desired so that the laser energy reacts directly with the material to be removed. Many polymer films are transparent to the commonly used laser wavelengths within the range of 355 nm to 1070 nm; consequently, the conventional thinking is that these polymer films need lasers with shorter wavelengths, less than 355 nm, for ablation processing. Such shorter wavelengths can be generated using complex crystal materials for fourth harmonic generation from 1064 nm fundamental lasers or using expensive gas based cavities such as excimer lasers, which excimer lasers need complex masks to create the desired ablation patterns. Using a Q-switched focused laser beam typically results in MW peak energy levels that will at a minimum cause thermal effects on surrounding materials if not complete ablation of unintended layers below the targeted polymer material. There thus remains a need for methods and apparatuses that can remove transparent materials without significant damage to the underlying materials and without using expensive equipment and complex processes.

### SUMMARY

According to certain aspects, embodiments of the present disclosure relate to methods and apparatuses for laser ablation of transparent materials using laser wavelengths that have a low absorption characteristic with respect to such materials. Embodiments of the present disclosure use standard industrial lasers with common optics and scanners for flexible pattern generation to remove transparent materials without significant damage to the underlying materials. In these and other embodiments, methods according to the present disclosure include defocusing or shaping the laser beam, effectively reducing the energy density of the laser beam below the ablation threshold of the underlying metal layers and using multiple passes over the targeted material.

According to some embodiments, a method of selectively ablating an optically transparent material covering a metal layer of a device may comprise: providing a layer of optically transparent material on a metal layer; and irradiating a portion of the layer of optically transparent material with a defocused laser beam and ablating the portion of the layer of optically transparent material; wherein the ablating leaves the metal layer completely intact and wherein the laser light has a wavelength within a range of 355 nm to 1070 nm.

According to some embodiments, a method of selectively ablating an optically transparent material covering a metal layer of a device may comprise: providing a layer of optically transparent material on a metal layer; and irradiating a portion of the layer of optically transparent material with a shaped laser beam and ablating the portion of the layer of optically transparent material; wherein the ablating leaves the metal layer completely intact and wherein the laser light has a wavelength within a range of 355 nm to 1070 nm.

According to some embodiments, an apparatus for forming thin film electrochemical devices comprising: a first system for blanket depositing a stack of a cathode current collector layer, a cathode layer, an electrolyte layer, an anode layer and an anode current collector layer on a substrate; a second system for laser die patterning the stack to form a multiplicity of die patterned stacks; a third system for laser patterning the multiplicity of die patterned stacks to reveal contact areas of at least one of the cathode current collector layer and the anode current collector layer for each of the multiplicity of die patterned stacks, forming a multiplicity of device stacks; a fourth system for depositing a blanket encapsulation layer over the multiplicity of device stacks; and a fifth system for laser ablating the blanket encapsulation layer to reveal contact areas of the cathode current collector layer and the anode current collector layer for each of the multiplicity of device stacks, forming a multiplicity of encapsulated device stacks; wherein the encapsulation layer is optically transparent, wherein the fifth system for laser ablation comprises a laser providing laser light with a wavelength within a range of 355 nm to 1070 nm, and wherein the fifth system for laser ablation is configured to provide a laser beam selected from the group consisting of a defocused laser beam and a shaped laser beam.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIGS. 1 and 2 are cross-sectional views of a thin film battery (TFB) illustrating aspects of a laser ablation methodology according to some embodiments of the present disclosure;

FIGS. 3 to 5 are top views of a TFB illustrating additional aspects of a laser ablation methodology according to embodiments of the disclosure;

FIGS. 6 and 7 are schematic diagrams illustrating laser beam defocusing, according to embodiments of the disclosure;

FIGS. 8 and 9 are laser beam intensity profiles for Gaussian and shaped beams, according to embodiments of the disclosure; and

FIG. 10 is schematic diagrams illustrating a linear processing apparatus, according to embodiments of the disclosure.

### DETAILED DESCRIPTION

Embodiments of the present disclosure will now be described in detail with reference to the drawings, which are provided as illustrative examples of the disclosure so as to enable those skilled in the art to practice the disclosure. The drawings provided herein include representations of devices and device process flows which are not drawn to scale. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present disclosure, an embodiment showing a singular component should not be considered limiting; rather, the disclosure is intended to encompass other embodiments including a plurality of the same component, and vice-versa, unless explicitly stated otherwise herein. Moreover, it is not intended for any term in the present disclosure to be ascribed an uncommon or special meaning unless explicitly set forth as such. Further, the present disclosure encompasses present and future known equivalents to the known components referred to herein by way of illustration.

According to certain general aspects, the author of the present disclosure has discovered that it is possible to use standard industrial lasers with common optics and scanners for flexible pattern generation to remove transparent materials without significant damage to the underlying materials. The author has further recognized that certain materials such as metals which are normally reflective to many laser wavelengths may be directly ablated by direct ionization of the normally reflective metal if sufficient energy is directed to the material surface—such as in the case of a high energy pulsed laser focused on the material. Alternatively, it is possible to super heat the metal inducing a molten state that has different absorption characteristics than the solid state of the material resulting in “explosive boiling”.

According to certain other aspects of the present disclosure, the author has discovered that by defocusing the laser beam (effectively reducing the energy density) and using multiple passes over the targeted material, it is possible to avoid damage to the reflective metal layers below the transparent material thus reflecting and redirecting the beam back again into the transparent material. In the case of transparent polymers these materials will melt much faster than the metal below. After sufficient heating of the transparent material the author discovered that the absorption characteristic of the material changes, causing it to directly absorb the laser light and then rapidly be ablated from the substrate. This can be considered as a pre-conditioning of the normally transparent polymer layer into a highly absorbing state that then results in actual ablation without damage to the metal layers below. One advantage of this solution is it allows for use of inexpensive and manufacturing proven lasers producing light in the visible wavelength range instead of expensive excimer lasers needing shadow masks or of unproven solid state lasers using 266 nm or below that also need expensive optics and maintenance.

These and other aspects of the present disclosure will be described in more detail below in connection with an example embodiment of ablating transparent encapsulation material in a single sided thin film battery to expose contact areas to the battery anode current collector and cathode current collector layers. However, the disclosure is not limited to this example, and one skilled in the art will understand how to extend the principles thereof to double sided TFBs and, as well as to other technologies using polymer coatings over metal, such as FET manufacturing.

Herein, in some embodiments optical transparency of a layer of optically transparent material is defined as the layer absorbing less than or equal to 50% of the laser light from a laser beam on a single pass of the laser light through the layer of optically transparent material, and in embodiments optical transparency of a layer of optically transparent material is defined as the layer absorbing less than or equal to 20% of the laser light from the laser beam on a single pass of the laser light through the layer of optically transparent material. Since the optical transparency of materials varies as a function of wavelength, this definition of optical transparency is specific to the particular wavelength of the laser light. The laser light is at a wavelength within the range of 355 nm to 1070 nm.

Most solid state thin film batteries (i.e. TFBs) have encapsulation with a polymer coating to protect the electrolyte components from environmental contamination that will cause premature failure of the devices. However, the deposition of these protective layers completely covers the contact areas that still need to be opened in order to physically connect the battery to end user components.

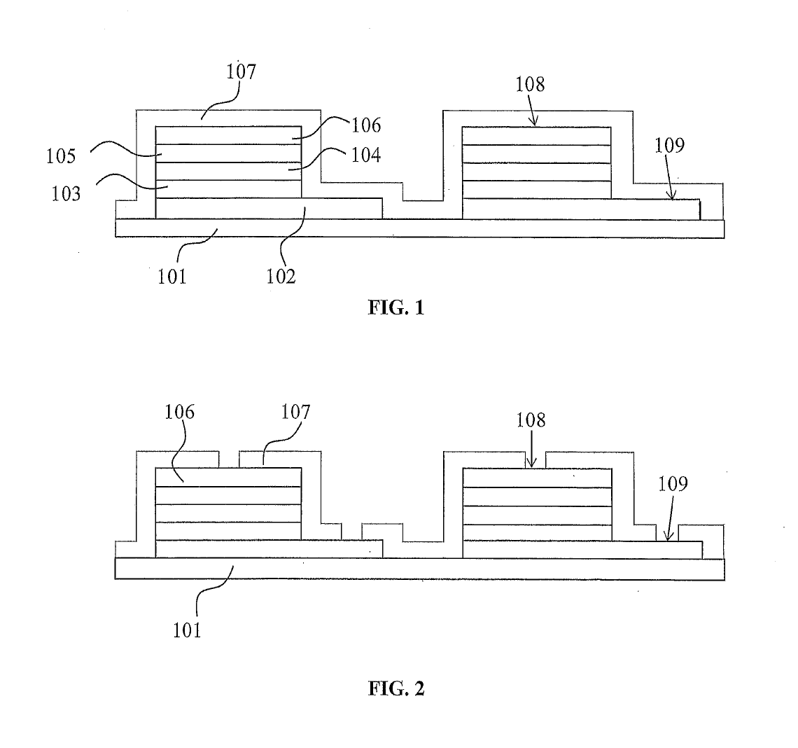

FIG. 1 is a cross-sectional view of an example where prior processing has completed a solid state thin film battery (TFB) stack with anode and cathode contact areas. This processing can be performed using maskless or mask techniques, or any combination of the two. A description of TFB devices that may advantageously utilize embodiments of the present disclosure is provided below with reference to FIGS. 1 and 2.

FIG. 1 shows an example of a vertical stack type TFB device structure comprising a substrate 101, a cathode current collector (CCC) layer 102 (e.g. Ti/Au), a cathode layer 103 (e.g. LiCoO₂), an electrolyte layer 104 (e.g. LiPON), an anode layer 105 (e.g. Li, Si), an anode current collector (ACC) layer 106 (e.g. Ti/Au), contact areas 108 and 109 for ACC and CCC, respectively, and a blanket encapsulation layer 107 (a polymer such as parylene).

According to embodiments the TFB device of FIG. 1 may be fabricated by the following process: provide substrate; blanket deposit CCC, cathode, electrolyte, anode, and ACC to form a stack; cathode anneal; laser pattern stack; deposit patterned contact pads; deposit encapsulation layer; laser pattern encapsulation layer. In embodiments the cathode is LiCoO₂ and the anneal is at a temperature of up to 850° C.

The specific TFB device structure and methods of fabrication provided above with reference to FIG. 1 is merely an example and it is expected that a wide variety of different TFB and other electrochemical device structures and fabrication methods may benefit from processing according to embodiments of the present disclosure as described herein.

Furthermore, a wide range of materials may be utilized for the different TFB device layers. For example, a cathode layer may be a LiCoO₂ layer (deposited by e.g. RF sputtering, pulsed DC sputtering, etc.), an anode layer may be a Li metal layer (deposited by e.g. evaporation, sputtering, etc.), and an electrolyte layer may be a LiPON layer (deposited by e.g. RF sputtering, etc.). However, it is expected that the present disclosure may be applied to a wider range of TFBs comprising different materials. Furthermore, deposition techniques for these layers may be any deposition technique that is capable of providing the desired composition, phase and crystallinity, and may include deposition techniques such as PVD, PECVD, reactive sputtering, non-reactive sputtering, RF sputtering, multi-frequency sputtering, electron and ion beam evaporation, thermal evaporation, CVD, ALD, etc.; the deposition method can also be non-vacuum based, such as plasma spray, spray pyrolysis, slot die coating, screen printing, etc. For a PVD sputter deposition process, the process may be AC, DC, pulsed DC, RF, HF (e.g., microwave), etc., or combinations thereof. Examples of materials for the different component layers of a TFB may include one or more of the following. The ACC and CCC may be one or more of Ag, Al, Au, Ca, Cu, Co, Sn, Pd, Zn and Pt which may be alloyed and/or present in multiple layers of different materials and/or include an adhesion layer of a one or more of Ti, Ni, Co, refractory metals and super alloys, etc. The cathode may be LiCoO₂, V₂O₅, LiMnO₂, Li₅FeO₄, NMC (NiMnCo oxide), NCA (NiCoAl oxide), LMO (LiₓMnO₂), LFP (LiₓFePO₄), LiMn spinel, etc. The solid electrolyte may be a lithium-conducting electrolyte material including materials such as LiPON, LiI/Al₂O₃ mixtures, LLZO (LiLaZr oxide), LiSiCON, Ta₂O₅, etc. The anode may be Li, Si, silicon-lithium alloys, lithium silicon sulfide, Al, Sn, C, etc.

The anode/negative electrode layer may be pure lithium metal or may be a Li alloy, where the Li is alloyed with a metal such as tin or a semiconductor such as silicon, for example. The Li layer may be about 3 μm thick (as appropriate for the cathode and capacity balancing) and the encapsulation layer may be 3 μm or thicker. The encapsulation layer may be a multilayer of polymer/parylene and metal and/or dielectric, and may be formed by repeated deposition and patterning, as needed. Note that, between the formation of the Li layer and the encapsulation layer, in some embodiments the part is kept in an inert or very low humidity environment, such as argon gas or in a dry-room; however, after blanket encapsulation layer deposition the need for an inert environment will be relaxed. The ACC may be used to protect the Li layer allowing laser ablation outside of vacuum and the need for an inert environment may be relaxed.

Furthermore, the metal current collectors, both on the cathode and anode side, may need to function as protective barriers to the shuttling lithium ions. In addition, the anode current collector may need to function as a barrier to oxidants (e.g. H₂O, O₂, N₂, etc.) from the ambient. Therefore, the current collector metals may be chosen to have minimal reaction or miscibility in contact with lithium in “both directions”—i.e., the Li moving into the metallic current collector to form a solid solution and vice versa. In addition, the metallic current collector may be selected for its low reactivity and diffusivity to the oxidants from the ambient. Some potential candidates for acting as protective barriers to shuttling lithium ions may be Cu, Ag, Al, Au, Ca, Co, Sn, Pd, Zn and Pt. With some materials, the thermal budget may need to be managed to ensure there is no reaction/diffusion between the metallic layers. If a single metal element is incapable of meeting both needs, then alloys may be considered. Also, if a single layer is incapable of meeting both needs, then dual (or multiple) layers may be used. Furthermore, in addition an adhesion layer may be used in combination with a layer of one of the aforementioned refractory and non-oxidizing layers—for example, a Ti adhesion layer in combination with Au. The current collectors may be deposited by (pulsed) DC sputtering of metal targets (approximately 300 nm) to form the layers (e.g., metals such as Cu, Ag, Pd, Pt and Au, metal alloys, metalloids or carbon black). Furthermore, there are other options for forming the protective barriers to the shuttling lithium ions, such as dielectric layers, etc.

In embodiments one or more of the component device layers such as anode, cathode, ACC, CCC, electrolyte and encapsulation layer may comprise multiple layers. For example, a CCC layer may comprise a layer of Ti and a layer of Pt or a layer of alumina, a layer of Ti and a layer of Pt, an encapsulation layer may comprise multiple layers as described above, etc.

As further shown in FIG. 1, a transparent polymer coating (encapsulation layer 107) has been deposited completely over the substrate, including the contact areas (108 & 109). In one example, the transparent coating is a parylene polymer. In another example, the transparent coating comprises both parylene polymer and alumina and/or silicon nitride films. In these and other examples, the transparent coating may be a multi-layer coating.

FIG. 2 is a cross-sectional view illustrating an example of a TFB after processing according to embodiments of the disclosure. As shown, openings to the Au or Ti/Au and Cu or TiO₂/Cu metal cathode 109 and anode 108 contact areas, respectively, have been formed without any damage to the metal layers using laser ablation processing to be described in more detail below. According to aspects of the present disclosure, even if the polymer coatings vary in thickness or if there are slight differences in absorption characteristics, the laser process can be robust enough to deal with these variations without damaging the metal layers. Those skilled in the art will recognize how to achieve such variations after being taught by the examples below. It should be noted that alternative masking or etching processes that are part of conventional methods are much more complicated and costly so laser processes using commercially available lasers according to the present disclosure is highly attractive.

It should be noted that the present disclosure is not limited to a single transparent material removal step. For example, a plurality of stack-up cycles of depositing an encapsulation layer, using the same or different materials in each cycle, and opening contact areas in the deposited encapsulation layer can be performed after one or more of the cycles. For example, a first cycle can deposit parylene followed by a second cycle of depositing alumina. As another example, a first cycle can deposit alumina followed by a second cycle of depositing parylene. As a further example, a first cycle can deposit parylene followed by a second cycle of depositing silicon nitride followed by a third cycle of depositing alumina.

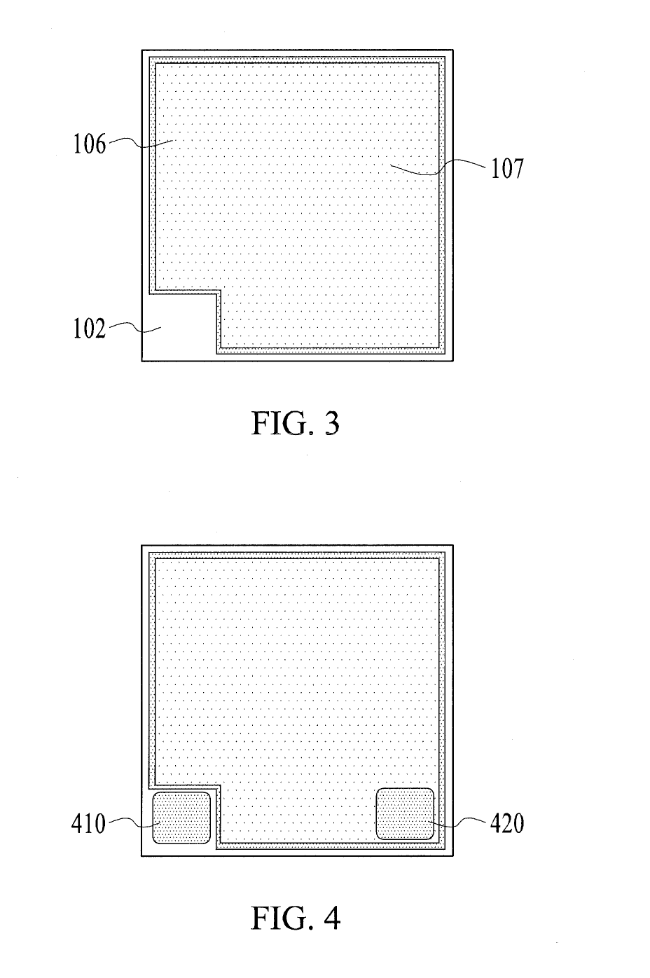

FIGS. 3, 4 and 5 are top views illustrating aspects of an example laser ablation process according to the present disclosure. FIG. 3 is a top view corresponding to the cross-sectional view in FIG. 1 above, showing a TFB stack of a single TFB cell completely covered by a transparent polymer material 107. It should be noted that although FIG. 3 only illustrates the boundary of a single battery cell, it should be apparent that a single substrate that can be processed according to the disclosure likely includes a plurality, and possibly hundreds, of batteries, depending on the battery type, substrate dimensions, whether the process is 2D or 3D, etc.

FIG. 4 is a top view illustrating laser ablation processing according to embodiments of the disclosure. The processing includes defocusing the laser beam, effectively reducing the energy density, and making multiple passes over the targeted material covering the anode and cathode contact areas. The processing further includes maintaining the laser beam below the ablation threshold of the bottom metal layers while the transparent material becomes molten. As indicated in FIG. 4, this processing results in a near instantaneous change of absorption characteristic of the transparent material, making the material more absorbent of the laser light—the darker coloration of the material at this point is indicative of the increased absorption of the visible laser light. (Dark coloration of the material over the cathode and anode contact areas is indicated by 410 and 420, respectively.) This allows for a pre-conditioning of the normally transparent polymer layer into a highly absorbing state, causing its eventual ablation. Note that for a layer of transparent material such as parylene at 355 nm the absorption of light is about 20%. By reflecting off of the metal surface below the parylene layer the absorption effectively doubles to about 40%.

Returning to FIG. 4, in one non-limiting example, the overall area of the battery device is about 1×10⁻² cm², and the pad areas to be exposed are about 4×10⁻⁴ cm². In this example, where the transparent material is a parylene layer about 10-20 microns thick, a picosecond laser is used with a wavelength of 355 nm. One example is a diode-pumped solid state (DPSS) laser, in embodiments a 355 nm laser. In some embodiments, a defocused laser beam is formed by a 355 nm laser and the defocused laser beam provides a dose rate in the range of 4×10⁸ Jm⁻²s⁻¹ to 6×10⁸ Jm⁻²s⁻¹ at the layer of optically transparent material—a dose rate of 5×10⁸ Jm⁻²s⁻¹ can be delivered with 10 μJ per pulse, 500,000 pulses per second over an area of 10⁴ square microns. It should be noted that an aspect of this disclosure is that such commercially available lasers are relatively less expensive to acquire and operate than other lasers having lower wavelengths considered desirable for ablating polymer materials such as parylene. Other possible picosecond laser wavelengths that can be used in connection with the present disclosure include 532 nm and 1064 nm. In other embodiments, a femtosecond laser is used, having a wavelength of 355 nm. In further embodiments, a nanosecond laser can be used.

According to aspects of the present disclosure, rather than focusing the laser beam near the surface of the transparent material, the beam is defocused. For example, with a beam spot size of about 100 μm, the beam is defocused by about 400%. More particularly, with a 2 mm focus window, the laser is placed 8mm out of focus. Other relevant settings, specifically for a 355 nm laser, include pulse energy of about 30 μJ and 12 ps pulse duration. To ablate the transparent material in the pad areas using these settings, the laser is operated over the pad areas in a cross-hatch pattern, with 20 micron steps. In one example, six completions of the pattern elapsing a total time of about 100 ms are needed to fully ablate a 10-20 micron thick layer of parylene material in each pad area using the 355 nm laser with operating parameters as given above.

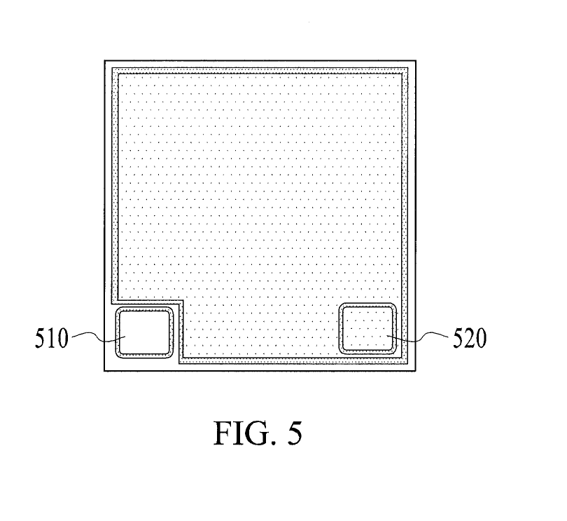

As shown in FIG. 5, the processing described above in connection with FIG. 4 results in actual ablation of the polymer material in the contact areas without damage to the metal layers below—clear cathode and anode contact areas 510 and 520, respectively, are shown. It should be noted that FIGS. 3 to 5 illustrate an example TFB cell surrounded by a die pattern. In embodiments, the laser processing of the present disclosure can also be used to remove the transparent material covering this die pattern. In other embodiments, other processing is used, such as direct focused ablation.

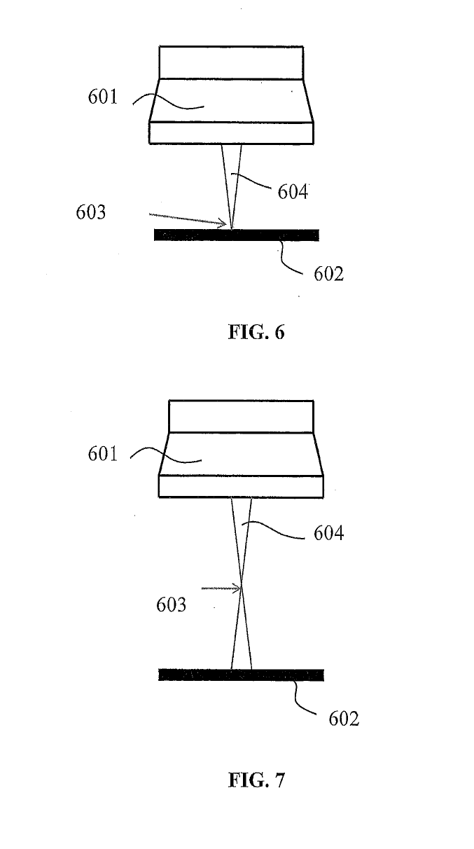

FIGS. 6-9 illustrate the above and other example aspects of a laser ablation methodology according to embodiments of the present disclosure in alternative detail.

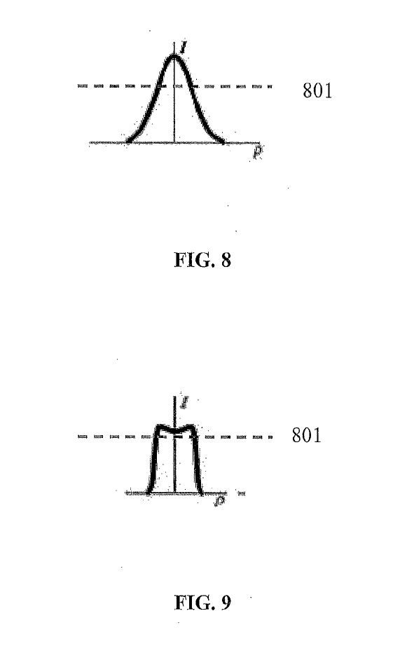

As shown in FIG. 6, in typical processing, a laser is used with a focus lens 601 and/or relative substrate 602 position adjusted so that the focal position 603 of the beam 604 is at or very close to the surface of a substrate being processed. In contrast, as shown in FIG. 7, in processing according to embodiments of the disclosure, the focus lens 601 and/or relative substrate 602 position is adjusted so that the beam 604 is defocused at the surface of the substrate. In the example described above, a 400% defocus is used.

As further shown in FIGS. 8 and 9, according to further aspects, embodiments of the present disclosure cause the energy in the resulting laser beam impinging on the material to stay below the threshold of ablation for the underlying metal layers. In addition to or alternatively to defocusing the beam, this can be ensured by, for example, beam shaping optics that uniformly distribute the pulse energy over a relatively large area to avoid damaging the metal layers; for the shaped beam, the general idea is to reduce the Gaussian peak intensity, and a 5% to10% variation of the intensity across the flat top of a laser beam intensity profile has been found to work well. Compare FIG. 8 for a Gaussian beam profile which shows significant excess energy over the ablation threshold 801, with FIG. 9, according to embodiments of the present disclosure, which shows a shaped beam with a “top hat” profile with very little excess energy over the ablation threshold 801. It should be further noted that, depending on the type of laser used (e.g. femtosecond lasers), defocusing or beam shaping may not be necessary in all embodiments.

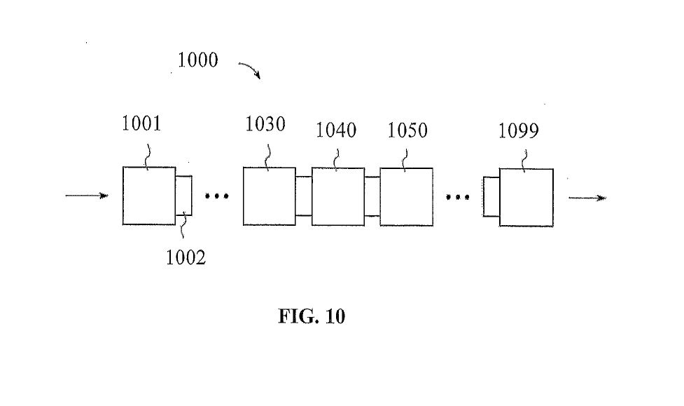

FIG. 10 shows a representation of an in-line fabrication system 1000 with multiple in-line tools 1001 through 1099, including tools 1030, 1040, 1050, according to some embodiments. In-line tools may include tools for depositing and patterning all the layers of a TFB, as well as the laser ablation tool, such as described herein, for removing encapsulation material from over the device contact pads. Furthermore, the in-line tools may include pre- and post-conditioning chambers. For example, tool 1001 may be a pump down chamber for establishing a vacuum prior to the substrate moving through a vacuum airlock 1002 into a deposition tool. Some or all of the in-line tools may be vacuum tools separated by vacuum airlocks. Note that the order of process tools and specific process tools in the process line will be determined by the particular TFB fabrication method being used, for example, as specified in the process flows described above. Furthermore, substrates may be moved through the in-line fabrication system oriented either horizontally or vertically. Yet furthermore, laser ablation tools may be configured for substrates to be stationary during ablation, or moving.

Although the examples of tools provided herein are for an in-line processing system, in embodiments laser ablation tools may be incorporated in cluster tools or as a stand-alone tool.

According to some embodiments, an apparatus for forming thin film electrochemical devices comprising: a first system for blanket depositing a stack of a cathode current collector layer, a cathode layer, an electrolyte layer, an anode layer and an anode current collector layer on a substrate; a second system for laser die patterning the stack to form a multiplicity of die patterned stacks; a third system for laser patterning the multiplicity of die patterned stacks to reveal contact areas of at least one of the cathode current collector layer and the anode current collector layer for each of the multiplicity of die patterned stacks, forming a multiplicity of device stacks; a fourth system for depositing a blanket encapsulation layer over the multiplicity of device stacks; and a fifth system for laser ablating the blanket encapsulation layer to reveal contact areas of the cathode current collector layer and the anode current collector layer for each of the multiplicity of device stacks, forming a multiplicity of encapsulated device stacks; wherein the encapsulation layer is optically transparent, wherein the fifth system for laser ablation comprises a laser providing laser light with a wavelength within a range of 355 nm to 1070 nm, and wherein the fifth system for laser ablation is configured to provide a laser beam selected from the group consisting of a defocused laser beam and a shaped laser beam. Furthermore, the laser beam can be formed by a 355 nm laser and the laser beam can provide a dose rate in the range of 4×10⁸ Jm⁻²s⁻¹ to 6×10⁸ Jm⁻²s⁻¹ at the blanket encapsulation layer. Furthermore, the apparatus may be an in-line processing apparatus. As above, in some embodiments the layer of optically transparent material can absorb less than or equal to 50% of the laser light from the defocused or shaped laser beam on a single pass of the laser light through the layer of optically transparent material, and in embodiments absorb less the or equal to 20% of the laser light. Furthermore; in some embodiments the fifth system for laser ablation is configured to scan the laser beam across the layer of optically transparent material during ablation of the layer of optically transparent material.

Furthermore, in some embodiments an apparatus for selectively ablating an optically transparent material covering a metal layer of a device may comprise a system for laser ablating a portion of a layer of optically transparent material, wherein the laser ablation tool comprises a laser providing laser light with a wavelength within a range of 355 nm to 1070 nm, and wherein the system for laser ablation is configured to provide a laser beam selected from the group consisting of a defocused laser beam and a shaped laser beam. Furthermore, the laser beam can be formed by a 355 nm laser and the laser beam can provide a dose rate in the range of 4×10⁸ Jm⁻²s⁻¹ to 6×10⁸ Jm⁻²s⁻¹ at the blanket encapsulation layer. Furthermore, the apparatus may be an in-line processing apparatus. As above, in some embodiments the layer of optically transparent material can absorb less than or equal to 50% of the laser light from the defocused or shaped laser beam on a single pass of the laser light through the layer of optically transparent material, and in embodiments absorb less the or equal to 20% of the laser light. Furthermore, in some embodiments the system for laser ablation is configured to scan the laser beam across the layer of optically transparent material during ablation of the layer of optically transparent material.

Although embodiments of the present disclosure have been described herein with reference to specific examples of TFB devices, process flows and manufacturing apparatus, the teaching and principles of the present disclosure may be applied to a wider range of TFB devices, process flows and manufacturing apparatus. For example, devices, process flows and manufacturing apparatus are envisaged for TFB stacks which are inverted from those described previously herein—the inverted stacks having ACC and anode on the substrate, followed by solid state electrolyte, cathode, CCC and encapsulation layer. For example, devices, process flows and manufacturing apparatus are envisaged for TFB stacks with coplanar current collectors. Furthermore, those of ordinary skill in the art would appreciate how to apply the teaching and principles of the present disclosure to generate a wide range of devices, process flows and manufacturing apparatus.

Although embodiments of the present disclosure have been described herein with reference to TFBs, the teaching and principles of the present disclosure may also be applied to improved devices, process flows and manufacturing apparatus for fabricating other electrochemical devices, including electrochromic devices. Those of ordinary skill in the art would appreciate how to apply the teaching and principles of the present disclosure to generate devices, process flows and manufacturing apparatus which are specific to other electrochemical devices.

Although embodiments of the present disclosure have been described herein with reference to TFBs, the teaching and principles of the present disclosure may also be applied to improved devices, process flows and manufacturing apparatus for fabricating other devices, including: microelectronic devices such as field effect transistors (FETs), and thermoelectric devices. Those of ordinary skill in the art would appreciate how to apply the teaching and principles of the present disclosure to generate devices, process flows and manufacturing apparatus which are specific to other devices.

Although embodiments of the present disclosure have been described herein with reference to parylene, specifically parylene-C, as an example of an optically transparent material, both parylene-N and silicone have also been demonstrated to behave as optically transparent materials as described in the present disclosure: Furthermore, it is expected that hexamethyldisiloxane (HMDSO), 1,4-butanediol diacrylate (BDDA), and other similar materials are expected to behave as optically transparent materials as described in the present disclosure.

Although embodiments of the present disclosure have been particularly described with reference to certain embodiments thereof, it should be readily apparent to those of ordinary skill in the art that changes and modifications in the form and details may be made without departing from the spirit and scope of the disclosure.

1. A method of selectively ablating an optically transparent material covering a metal layer of a device, comprising:
providing a layer of optically transparent material on a metal layer; and
irradiating a portion of said layer of optically transparent material with a defocused laser beam and ablating said portion of said layer of optically transparent material;
wherein said ablating leaves said metal layer completely intact and wherein the laser light has a wavelength within a range of 355 nm to 1070 nm.

2. A method of selectively ablating an optically transparent material covering a metal layer of a device, comprising:
providing a layer of optically transparent material on a metal layer; and
irradiating a portion of said layer of optically transparent material with a shaped laser beam and ablating said portion of said layer of optically transparent material;
wherein said ablating leaves said metal layer completely intact and wherein the laser light has a wavelength within a range of 355 nm to 1070 nm.

3. The method as in claim 1, wherein said layer of optically transparent material absorbs less than or equal to 50% of the laser light from said laser beam on a single pass of said laser light through said layer of optically transparent material.

4. The method as in claim 1, wherein said layer of optically transparent material absorbs less than or equal to 20% of the laser light from said laser beam on a single pass of said laser light through said layer of optically transparent material.

5. The method as in claim 1, wherein said layer of optically transparent material is an encapsulation layer.

6. The method as in claim 1, wherein said layer of optically transparent material comprises parylene.

7. The method as in claim 1, wherein said optically transparent material comprises parylene-C, and wherein said layer of optically transparent material is in the range of 10 microns to 20 microns thick.

8. The method as in claim 1, wherein said laser beam is formed by a 355 nm laser and said laser beam provides a dose rate in the range of 4×108 Jm−2 s−1 to 6×108 Jm−2 s−1 at said layer of optically transparent material.

9. The method as in claim 1, wherein said electrochemical device is a thin film solid state battery.

10. The method as in claim 1, wherein said irradiating comprises scanning said laser beam multiple times over said portion of said layer of optically transparent material.

11. The method as in claim 1, wherein said metal layer is a current collector of a thin film solid state battery.

12. The method as in claim 11, wherein said metal layer comprises at least one metal chosen from the group consisting of gold, platinum, titanium and copper.

13. An apparatus for forming thin film electrochemical devices comprising:
a first system for blanket depositing a stack of a cathode current collector layer, a cathode layer, an electrolyte layer, an anode layer and an anode current collector layer on a substrate;
a second system for laser die patterning said stack to form a multiplicity of die patterned stacks;
a third system for laser patterning said multiplicity of die patterned stacks to reveal contact areas of at least one of said cathode current collector layer and said anode current collector layer for each of said multiplicity of die patterned stacks, forming a multiplicity of device stacks;
a fourth system for depositing a blanket encapsulation layer over said multiplicity of device stacks; and
a fifth system for laser ablating said blanket encapsulation layer to reveal contact areas of said cathode current collector layer and said anode current collector layer for each of said multiplicity of device stacks, forming a multiplicity of encapsulated device stacks;
wherein said encapsulation layer is optically transparent, wherein said fifth system for laser ablation comprises a laser providing laser light with a wavelength within a range of 355 nm to 1070 nm, and wherein said fifth system for laser ablation is configured to provide a laser beam selected from the group consisting of a defocused laser beam and a shaped laser beam.

14. The apparatus of claim 13, wherein said laser beam is formed by a 355 nm laser and said laser beam provides a dose rate in the range of 4×108 Jm−2 s−1 to 6×108 Jm−2 s−1 at said blanket encapsulation layer.

15. The apparatus of claim 13, wherein said apparatus is an in-line apparatus.

16. The method as in claim 2, wherein said layer of optically transparent material absorbs less than or equal to 50% of the laser light from said laser beam on a single pass of said laser light through said layer of optically transparent material.

17. The method as in claim 2, wherein said layer of optically transparent material absorbs less than or equal to 20% of the laser light from said laser beam on a single pass of said laser light through said layer of optically transparent material.

18. The method as in claim 2, wherein said layer of optically transparent material is an encapsulation layer.

19. The method as in claim 2, wherein said layer of optically transparent material comprises parylene.

20. The method as in claim 2, wherein said optically transparent material comprises parylene-C, and wherein said layer of optically transparent material is in the range of 10 microns to 20 microns thick.

21. The method as in claim 2, wherein said laser beam is formed by a 355 nm laser and said laser beam provides a dose rate in the range of 4×108 Jm−2 s−1 to 6×108 Jm−2 s−1 at said layer of optically transparent material.

22. The method as in claim 2, wherein said electrochemical device is a thin film solid state battery.

23. The method as in claim 2, wherein said irradiating comprises scanning said laser beam multiple times over said portion of said layer of optically transparent material.

24. The method as in claim 2, wherein said metal layer is a current collector of a thin film solid state battery.
